(19) United States
(12) Patent Application Publication
(10) Pub. No.: US 2025/0252167 A1
(43) Pub. Date: Aug. 7, 2025

(54) INFORMATION PROCESSING DEVICE, CONTROL METHOD OF INFORMATION PROCESSING DEVICE, AND STORAGE MEDIUM

(71) Applicant: CANON KABUSHIKI KAISHA, Tokyo (JP)

(72) Inventor: Hideki SORAKADO, Tokyo (JP)

(21) Appl. No.: 19/038,758

(22) Filed: Jan. 28, 2025

(30) Foreign Application Priority Data
Feb. 6, 2024 (JP) 2024-016552

(51) Int. Cl. G06F 21/32; G06V 20/52

(52) U.S. Cl. CPC G06F 21/32; G06V 20/52

(57) ABSTRACT

An information processing device includes at least one processor; and a memory coupled to the at least one processor, the memory storing instructions that, when executed by the at least one processor, cause the at least one processor to: acquire first data, authenticate a person based on the first data, perform a first determination of whether a person to be authenticated by the authentication is attempting the unauthorized authentication, and perform, in a case where it is determined that the unauthorized authentication is being attempted in the first determination, a second determination of whether the person to be authenticated is a suspicious person.

### BACKGROUND OF THE INVENTION

### Field of the Invention

The present invention relates to an information processing device, a control method of an information processing device, a storage medium, and the like.

### Description of the Related Art

In the past, there have been attacks that attempted to fraudulently authenticate against biometrics by presenting artifacts that imitate a living body. For example, in the case of facial recognition, there are attacks that attempt to impersonate someone else to be authenticated by presenting a printed photograph of the face image. There are impersonation detection technologies as a technology to detect such attacks.

Japanese Patent No. 6202983 describes setting the security strength according to the number of successful impersonation detections and implementing authentication a number of times that takes into account the trade-off between the strength and the processing load.

In addition, Japanese Patent Laid-Open No. 2013-149181 describes that to prevent impersonation in e-learning, a fraud determination is made after the e-learning study is completed based on the authentication results of the learner during the e-learning.

However, the introduction of impersonation detection had the problem of reducing system throughput. For example, if the technology of Japanese Patent No. 6202983 is applied to gate authentication, or the like, the user would have to stop at the gate every time when it is determined that there is impersonation.

Therefore, security is improved but throughput is reduced compared to when impersonation detection is not introduced. Also, in Japanese Patent Laid-Open No. 2013-149181, fraud determination is performed after the e-learning program is implemented, but this requires monitoring of fraud determination for all users, which requires computing resources.

### SUMMARY OF THE INVENTION

An information processing device as an aspect of the invention includes at least one processor; and a memory coupled to the at least one processor, the memory storing instructions that, when executed by the at least one processor, cause the at least one processor to: acquire first data, authenticate a person based on the first data, perform a first determination of whether a person to be authenticated by the authentication is attempting the unauthorized authentication, and perform, in a case where it is determined that the unauthorized authentication is being attempted in the first determination, a second determination of whether the person to be authenticated is a suspicious person.

Further features of the present invention will become apparent from the following description of embodiments with reference to the attached drawings.

### BRIEF DESCRIPTION OF THE DRAWINGS

FIG. 1 is a hardware configuration diagram of a computer device according to an embodiment.

FIG. 2 is a functional block diagram of an information processing device according to the embodiment.

FIGS. 3A and 3B are explanatory diagrams illustrating a status of processing performed by the information processing device in the embodiment.

FIG. 4 is a flowchart illustrating a flow of service control processing in the embodiment.

FIG. 5 is a block configuration diagram of an information processing device according to another embodiment.

FIG. 6 is a flowchart illustrating a flow of service control processing in still another embodiment.

FIG. 7 is a block configuration diagram illustrating of an information processing device according to further still another embodiment.

FIG. 8 is a flowchart illustrating a flow of service control processing in this further still another embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

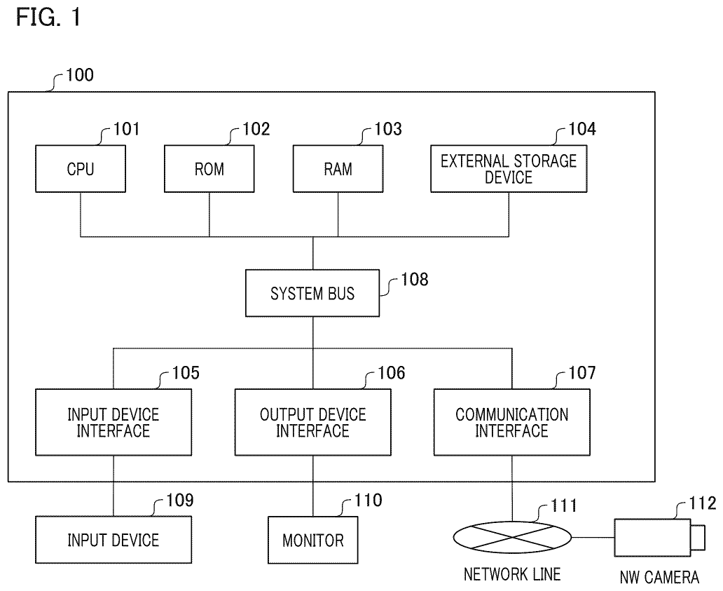

A hardware configuration of a computer device 100 of the present embodiment is described below with reference to FIG. 1. FIG. 1 is a block diagram illustrating a hardware configuration of the computer device 100 of the present embodiment.

The computer device 100 of the present embodiment has a CPU 101, a ROM 102, a RAM 103, an external storage device 104, an input device interface 105, an output device interface 106, and a communication interface 107. In addition, the computer device 100 of the present embodiment also functions as an information processing device.

The CPU (processor) 101 is the central processing unit that controls the entire computer device 100. The CPU 101 comprehensively controls each component of the computer device 100 by executing control programs stored in the ROM 102 and the RAM 103.

The CPU 101 is an abbreviation for Central Processing Unit. The ROM 102 is a nonvolatile memory for storing (memorizing), for example, control programs and various parameters that do not require modification. The ROM 102 is an abbreviation for Read Only Memory.

The RAM 103 is a volatile memory and temporarily stores programs and data supplied from external devices. The RAM 103 is an abbreviation for Random Access Memory.

The external storage device 104 is a storage device, such as a hard disk or memory card, fixedly installed in the computer device 100. The external storage device 104 may include a flexible disk (FD), optical disc such as a compact disc (CD), a magnetic or optical card, an IC card, a memory card, or the like that can be attached to or removed from the computer device 100.

The input device interface (input device I/F) 105 is an interface with an input device 109 such as a pointing device, a mouse, or a keyboard that receives user operations and inputs data.

The output device interface (output device I/F) 106 is an interface with a monitor (display) 110 for displaying various data, such as data saved or supplied by the computer device 100.

The communication interface 107 is a communication interface for connecting to a network line 111 such as the Internet. In the present embodiment, the interface is connected to the network camera (NW camera) 112 via the network line 111.

The NW camera 112 is an imaging device that captures video and images. In FIG. 1, one NW camera 112 is connected to the computer device 100 via the network line 111. However, this is not limited to this, and a plurality of NW cameras 112 may be connected to the computer device 100 via the network line 111.

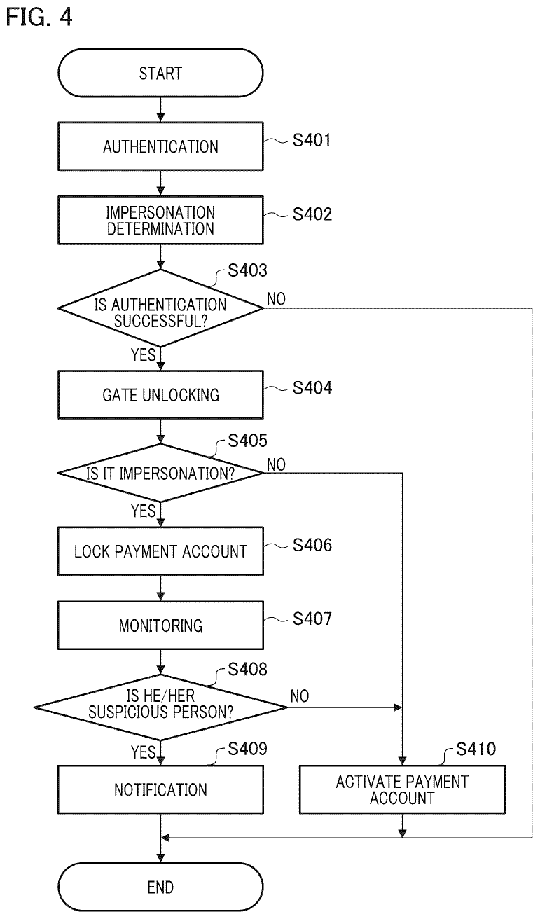

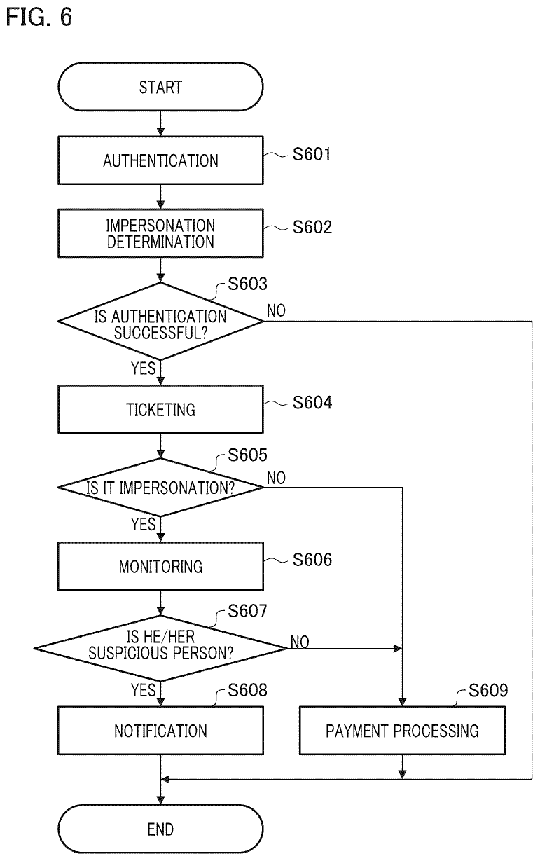

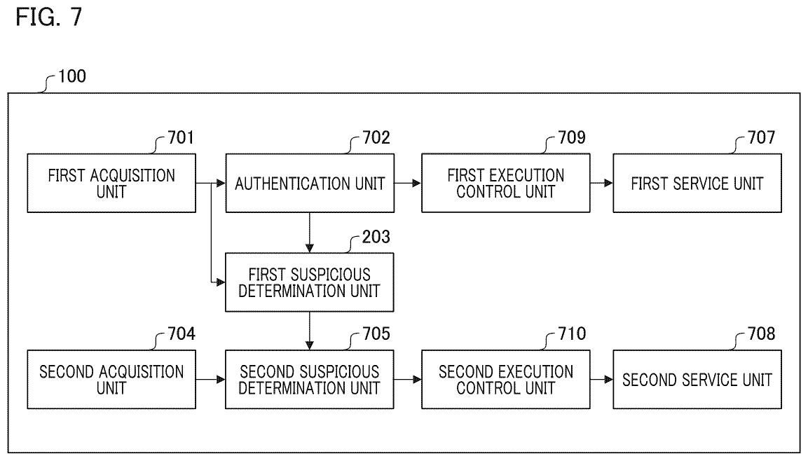

A system bus 108 is a transmission path that connects each unit from the CPU 101 to the communication interface 107 so that they can communicate with each other. Each step of the processing in FIG. 4, FIG. 6, and FIG. 7, described below, functions as processing when the CPU 101 executes a program stored in a computer-readable storage medium such as a ROM 102.

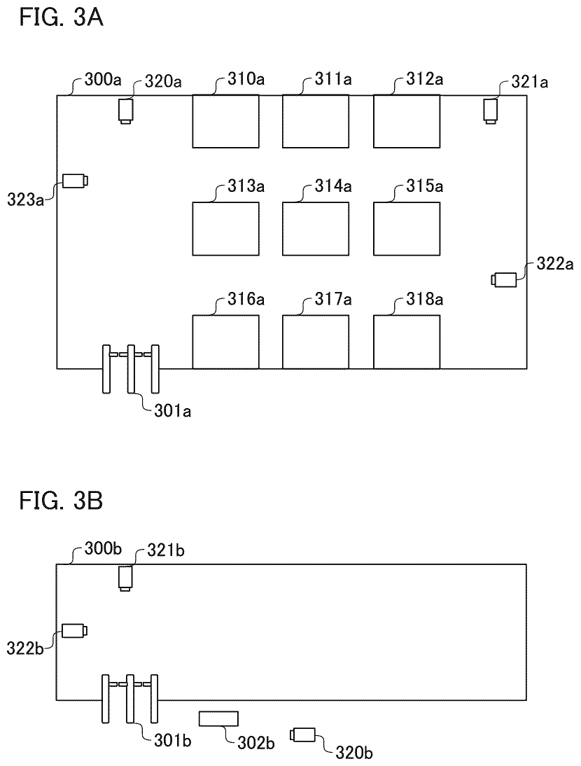

The status in which the present embodiment is applied is described below with reference to FIG. 3. FIGS. 3A and 3B are explanatory diagrams illustrating a status of processing performed by the computer device 100. FIG. 3A is an explanatory diagram illustrating a status of processing performed by the computer device 100 in the first embodiment.

FIG. 3B is an explanatory diagram illustrating a status of processing performed by the computer device 100 in the second embodiment. Thus, details in FIG. 3B are described below.

In the present embodiment, it is assumed that a face recognition system is installed in an event venue 300a. An entrance gate 301a is located at the entrance of the event venue 300a. The entrance gate 301a is an authentication device with an automatic gate function that physically permits or restricts entry, and is equipped with a camera or other imaging device.

The camera at the entrance gate 301a is provided at the entrance gate 301 to have a position and angle of view that allows the face of a person to be imaged. Here, the pre-registered person's face is imaged by the camera possessed by the entrance gate 301a, and after the predetermined authentication processing, entry is permitted and the gate opens, allowing the person to enter the event venue 300a.

Although not shown, exit gates are also located at the event venue 300a. The exit gate may be used as an authentication device with automatic gate functionality, similar to the entrance gate 301a. In addition, an attendant may be stationed at the exit gate, allowing free exit but not entry, and the gate may be non-automatic.

The event venue 300a has booths 310a, 311a, 312a, 313a, 314a, 315a, 316a, 317a, and 318a, each of booths sells goods and food and drink.

Information terminals for face recognition (facial recognition terminals) are located at each booth, and these face recognition terminals can be used for payment at each booth. As the payment, the payment is deducted from the deposit made at the time of application for the event in advance.

Alternatively, a credit card or the like may be registered and the fee may be debited from that account, or the fee may be settled using electronic money. Some booths may be manned, while others may be unmanned, such as vending booths.

In addition, NW cameras 320a, 321a, 322a, and 323a are also installed at the event venue. It is preferable that the NW cameras 320a, 321a, 322a, and 323a are installed in different positions within the event venue 300a as illustrated in FIG. 3A.

The computer device 100, the NW cameras 320a to 323a, the entrance gate 301a, and the face recognition terminal are connected via the network line 111a, or the like, and each is configured to enable control and communication.

Even if the computer device 100 of the present embodiment detects impersonation in the authentication processing, the entrance gate 301a is unlocked (first service) to permit entry, but processing is performed to lock the payment account of the user suspected of having performed impersonation (second service).

Thereafter, the NW cameras 320a to 323a monitor the behavior of the user within the event venue 300a, and in a case where the suspicion of impersonation is cleared, the processing of activating the payment account of the user (third service) is performed. On the other hand, in a case where the suspicion of impersonation is not cleared, the person is determined to be suspicious and security guards or other personnel are notified as prescribed.

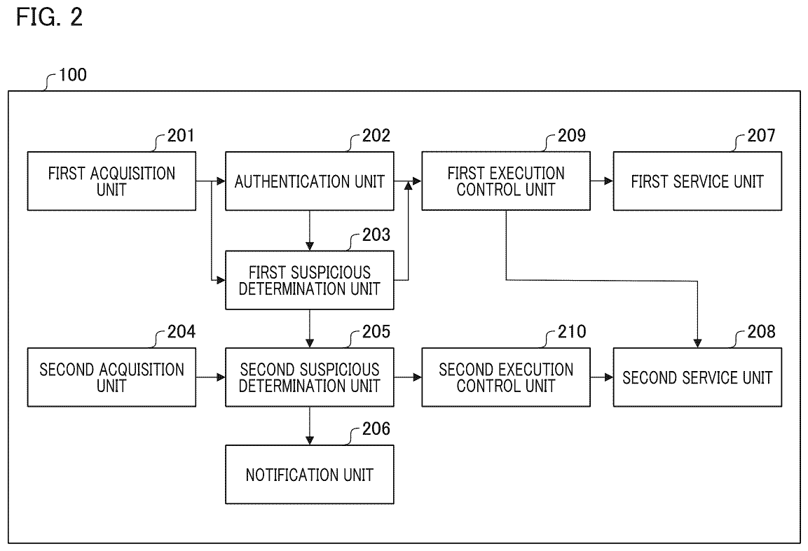

The functional configuration of the computer device 100 of the present embodiment will be described with reference to FIG. 2. FIG. 2 is a diagram illustrating a functional block configuration of the computer device 100 in the first embodiment.

The computer device 100 of the first embodiment includes a first acquisition unit 201, an authentication unit 202, a first suspicious determination unit 203, a second acquisition unit 204, a second suspicious determination unit 205, and a notification unit 206. The device further includes a first service unit 207, a second service unit 208, a first execution control unit 209, and a second execution control unit 210.

The first acquisition unit 201 acquires video data (first data) from the camera at the entrance gate 301a. In a case where a separate camera is disposed near the entrance gate 301a, the video data may be acquired from a camera disposed near the entrance gate 301a instead of the camera at the entrance gate 301a.

In a case where the camera is disposed near the entrance gate 301a, the camera is positioned so that the angle of view is such that at least the face of the person about to enter through the entrance gate 301a is imaged. In addition, in the case where a camera is disposed near the entrance gate 301a, the first acquisition unit 201 may acquire video data (first data) from each of the camera at the entrance gate 301a and the camera positioned near the entrance gate 301a.

The authentication unit 202 authenticates the person in the video data acquired by the first acquisition unit 201. Specifically, the face detection technology is used to detect the presence of a person in the acquired video data, and face recognition technology is used to identify who that person is.

Specifically, a registration database needs to be constructed with pre-registered facial images of users at the time of event registration, or the like. Then, the face detection technology is used to detect when a face appears in video data. RetinaFace or other methods can be used as a face detection technology.

Thereafter, the similarity between the detected face and faces registered in a registration database is calculated, and if there is a registered person whose similarity exceeds a predetermined value, the person in the video is identified as the registered person. The similarity between two face images may be calculated using a method such as ArcFace. In addition, information such as the account ID of registered person is saved in the registered database for linking with other services.

The first suspicious determination unit 203 determines whether a person (user) is attempting the unauthorized authentication in the authentication of the authentication unit 202. For example, it is determined whether a person is attempting authentication by fraudulently impersonating another person by presenting a printed photograph of a facial image, or presenting a smartphone or tablet displaying a facial image.

Specifically, the video data is acquired from the first acquisition unit 201 to determine whether the face used for authentication by the authentication unit 202 is a photograph or other impersonation. The determination method includes an impersonation detection technology that determines whether a subject is a living or non-living body from a facial image, and known methods may be used.

In the present embodiment, the first suspicious determination unit 203 uses a method to determine from the image whether the subject is a living or non-living body. However, a method for detecting impersonation by detecting the behavior of a subject holding a photograph in front of his or her face, for example, may also be used.

The second acquisition unit 204 acquires video data (second data) from each of the NW cameras 320a to 323a.

The second suspicious determination unit 205 determines whether a person who has been determined by the first suspicious determination unit 203 to be attempting the unauthorized authentication (a person who has been determined to be suspicious) is a suspicious person using the video data obtained from the second acquisition unit 204 (determines suspiciousness).

Specifically, when the first suspicious determination unit 203 determines that there is a person attempting the unauthorized authentication, the first suspicious determination unit 203 identifies the person using the video data (first data) from the NW camera 320a that reflects the entrance gate 301a.

Thereafter, the person who has been determined to be attempting the unauthorized authentication is tracked through a plurality of NW cameras (NW cameras 320a to 323a) in the event venue 300a using a tracking technology or the like, and the behavior of the person is monitored.

The second suspicious determination unit 205 determines whether the person who has been determined to be attempting the unauthorized authentication by the first suspicious determination unit 203 is a suspicious person based on the monitoring results (video data from a plurality of NW cameras).

An example of suspicious behavior is having a different face than when the person entered the venue. In this case, even if the person passes through the entrance gate by holding up a photograph or other object, in a case where the person stops holding it up after entering the gate, the face of the person will be different from the one at the time of entry.

In a case where the above suspicious behavior is detected from the monitoring results, the second suspicious determination unit 205 can determine that the person who has been determined to be attempting the unauthorized authentication by the first suspicious determination unit 203 is a suspicious person.

Thus, the second suspicious determination unit 205 determines whether the person is a suspicious person or not based on the behavior of the person who has been determined by the first suspicious determination unit 203 to be attempting the unauthorized authentication.

Alternatively, in a case where the action of lowering a photograph being held up or the action of removing a headgear such as a costume mask is detected from the monitoring result, the second suspicious determination unit 205 may determine that the person who has been determined to be attempting the unauthorized authentication is a suspicious person.

Furthermore, in addition to those cases, in a case where a behavior seen in people under stress or an intentional attempt to escape from the security camera is detected from the monitoring result, the second suspicious determination unit 205 may also determine that the person who has been determined to be attempting the unauthorized authentication is a suspicious person.

In addition, in a case where an action of putting away the photograph holding up is detected from the monitoring result by continuing to follow a person from the entrance gate, the second suspicious determination unit 205 may determine that the person who has been determined to be attempting the unauthorized authentication is a suspicious person.

In addition, in a case where an action of passing through a public place without being seen removing headgear or other items used for impersonation is detected from the monitoring result, the second suspicious determination unit 205 may determine that the person who has been determined to be attempting the unauthorized authentication is a suspicious person.

Thus, since it clearly looks suspicious if the person holds a photograph in front of their face or if the person is wearing a headgear, if someone walked through a public place dressed like that, they would stand out as a suspicious individual. Therefore, it can be determined that the person is not suspicious individual if such behavior is not present by the time he or she passes through a public place. The above is only one example of suspicious behavior and the determination method of suspicious people is not limited to the above methods.

The notification unit 206 notifies security guards and others when a person who has been determined by the first suspicious determination unit 203 to be attempting the unauthorized authentication is determined by the second suspicious determination unit 205 to be a suspicious person.

Specifically, a monitor 110a or the like is disposed in a security room or other location to display and notify security guards of suspicious people. Alternatively, it can be used to produce sound on a loudspeaker, or the like. Alternatively, the current NW camera video reflecting a suspicious person, the location of the NW camera and the location of the suspicious person may be displayed on the monitor 110a.

In addition, the monitor 110a may also display video and other images when the first suspicious determination unit 203 determines the suspicious activity. Alternatively, the registered people authenticated by the authentication unit 202 may be displayed, and the monitor 110a may display which registered person the person impersonated. The above notification methods and notification contents are merely examples and are not limited to these.

The first service unit 207 controls the unlocking and locking (opening and closing) of the entrance gate 301a to allow or restrict entry to the event venue 300a.

The second service unit 208 implements payment control for the sale of goods, or the like at each booth in the event venue 300a. A facial recognition terminal installed at each booth identifies the person making the payment from a registration database, and the payment is made using the payment method associated with that registered person.

For example, fees are deducted from a pre-paid deposit. Alternatively, the payment is made by credit card, or the like. In addition, the payment service by the second service unit 208 can lock the account, and the payment will fail while the account is locked. Accordingly, the affected person will not be able to make payments at the booth.

The first execution control unit 209 controls the first service unit 207 to execute the first service. In addition, it controls the second service unit 208 to execute the second service. Specifically, in a case where the authentication of the authentication unit 202 is successful, the first service unit 207 is controlled to unlock the entrance gate 301a.

In addition, in a case where the first suspicious determination unit 203 determines that unauthorized authentication is being attempted, the second service unit 208 is controlled to lock the payment account of the person authenticated by the authentication unit 202.

Thus, the first execution control unit 209 controls the first service unit 207 to unlock the entrance gate 301a as the first service. In addition, the first execution control unit 209 also controls the second service unit 208 to lock the payment account of the person authenticated by the authentication unit 202 (control of payment) as the second service.

The second execution control unit 210 controls the second service unit 208 to execute a third service for unlocking the second service. Specifically, when a person who has been determined by the first suspicious determination unit 203 to be attempting the unauthorized authentication is determined by the second suspicious determination unit 205 not to be a suspicious person, the second service unit 208 is controlled to unlock the payment account of the affected person.

This will activate the account of the affected person, allowing the effected person to make payments at the booth. Thus, the second execution control unit 210 unlocks the payment account of a person whose payment account has been locked as a third service.

For software-enabled functions among the functional blocks illustrated in FIG. 2, programs for providing the functions of each functional block are stored in a memory such as the ROM 102. The program is then read into the RAM 102 and executed by the CPU 101, thereby achieving the above-described function.

For functions realized by hardware, for example, a dedicated circuit can be automatically generated on the FPGA from a program to realize the functions of each functional block by using a specified compiler.

FPGA is an abbreviation for Field Programmable Gate Array. In addition, the gate array circuit may be formed in the same manner as the FPGA, and the circuit may be realized as hardware.

In addition, it may be realized by an application specific integrated circuit (ASIC). The configuration of functional blocks illustrated in FIG. 2 is an example, and a plurality of functional blocks may constitute a single functional block, or any functional block may be divided into blocks that perform multiple functions.

Next, the service control processing flow in the present embodiment is described with reference to the flowchart in FIG. 4. FIG. 4 is a flowchart illustrating a flow of service control processing in the present embodiment. In addition, each process (step) is represented by adding S to the beginning of the process (step), thereby abbreviating the notation of the process (step).

In S401, the authentication unit 202 searches for the person (user) who visited the entrance gate 301a from the registration database and performs the person authentication processing. In the person authentication processing, the person visiting the entrance gate 301a is imaged with the camera at the entrance gate 301a.

Next, the video data (first data) imaged by the camera is acquired by the first acquisition unit 201. Next, the authentication unit 202 detects a person from the acquired video data (first data) using face detection technology and identifies who that person is.

Specifically, the authentication unit 202 calculates the similarity between the detected person's face and the face registered in the registration database, and identifies the person in the video data (first data) as a registered person in a case where any registered person exceeds the specified similarity.

That is, it is determined that the authentication of a person attempting to enter through the entrance gate 301a has been successful. On the other hand, in a case where no registered person exceeds the predetermined similarity, the person in the video data (first data) is not identified as a registered person.

In other words, it is determined that the authentication of the person attempting to enter through the entrance gate 301a has failed. By processing of S401, it is possible to identify which person is the person who visits the entrance gate 301a and tries to enter the event venue 300a.

In S402, the first suspicious determination unit 203 determines whether the person whose authentication processing was performed by the authentication unit 202 in S401 was attempting the unauthorized authentication. Specifically, the first suspicious determination unit 203 determines whether the affected person is attempting to impersonate by holding up a photograph for the camera or by other means (whether an act of impersonation is performed).

In S403, the first suspicious determination unit 203 determines whether the authentication of the person whose authentication processing was performed by the authentication unit 202 in S401 was successful or not. In a case where the authentication is successful, the processing proceeds to S404.

On the other hand, in a case where the authentication fails, the processing ends. In other words, in a case where the authentication fails in S401, the entrance gate 301a is not unlocked, and the person whose authentication processing was performed by the authentication unit 202 in S401 cannot enter the event venue 300a.

In S404, the first execution control unit 209 controls the first service unit 207 to unlock the gate of the entrance gate 301a and allow the person who was subject to authentication in S401 to enter the event venue 300a (execution of the first service).

In other words, the first execution control unit 209 controls the first service unit 207 to execute the first service regardless of the determination result by the first suspicious determination unit 203 (whether the person whose authentication processing was performed by the authentication unit 202 in S401 was attempting the unauthorized authentication).

It is assumed that the entrance gate 301a is not an authentication device with an automatic gate function, but is a gate, for example, where an attendant or other relevant person is stationed and determines whether to permit entry at the attendant's discretion.

In such a case, a notification will be sent to an electronic device such as a tablet or smartphone carried by the attendant indicating that entry is permitted, and the attendant may allow the affected person to enter the event venue 300a based on the notification. In a case where the entry is denied, the attendant will inform the person who is trying to enter and will not permit that person to enter.

In S405, the first suspicious determination unit 203 determines whether the unauthorized authentication was attempted (whether it was impersonation or not) in S402. In a case where the determination result of S402 is impersonation, the processing proceeds to S406. On the other hand, in a case where the determination result of S402 is not impersonation, the processing proceeds to S410.

In S406, the first execution control unit 209 locks the payment account of the registered person identified in S401 (execution of the second service). Specifically, the account ID of the second service unit 208 associated with the registered person is acquired.

The first execution control unit 209 then notifies the second service unit 208 to lock the account. Thereafter, the second service unit 208, which has received the notification to lock the account from the first execution control unit 209, locks the account and prohibits payment.

Thus, the first execution control unit 209 executes the control of payment as the second service according to the determination result of the first suspicious determination unit 203. That is, the first execution control unit 209 controls the second service unit 208 to execute a lock on the payment account as the second service to the person in a case where the first suspicious determination unit 203 determines that the person is attempting the unauthorized authentication.

In S407, the second suspicious determination unit 205 monitors the person who has been determined to be attempting the unauthorized authentication in S402 using the NW cameras 320a to 323a disposed at the event venue 300a.

During the monitoring, the second acquisition unit 204 acquires the video data (second data) that is the monitoring result from the NW cameras 320a to 323a. It is preferable that the second acquisition unit 204 acquires the video data (second data) that is the monitoring result from each NW camera that is disposed.

However, it is not limited thereto, and the second data may be acquired from at least one NW camera capable of capturing images of the person who has been determined to be attempting the unauthorized authentication in S402.

In S408, the second suspicious determination unit 205 determines whether the person who has been determined to be attempting the unauthorized authentication in S402 is a suspicious person based on the video data (second data) that is the monitoring result acquired by the second acquisition unit 204 in S407.

In a case where the person who has been determined to be attempting the unauthorized authentication in S402 is determined to be a suspicious person, the processing proceeds to S409. On the other hand, in a case where the person who has been determined to be attempting the unauthorized authentication in S402 is not determined to be a suspicious person, the processing proceeds to S410.

In a case where the person is not determined as suspicious in S408, it means that the first suspicious determination unit 203 erroneously determined that the person to be authenticated is a person who is attempting the unauthorized authentication, but the second suspicious determination unit 205 has corrected the determination as not suspicious (not a suspicious person).

In S409, the notification unit 206 notifies security guards and other relevant people of the presence of a suspicious individual (who was determined to be a suspicious person in S408). That is, the notification is made in a case where the person who has been determined to be suspicious in S402 by the second suspicious determination unit 205 is determined to be a suspicious person.

As a notification, for example, the monitor 110a may be disposed in a security room, or the like, and a suspicious person may be displayed and notified to the security guard, or the information may be displayed on the monitor of an information terminal such as a tablet or smartphone carried by the security guard.

In S410, the second execution control unit 210 activates the payment account of the registered person identified in S401 (execution of the third service). Specifically, the account ID of the second service unit 208 associated with the registered person is acquired.

The second service unit 208 is then notified to activate the account. The second service unit 208 allows payment to be made using the account. In a case where the payment account was locked in S406, the lock is unlocked and the account is activated.

That is, the second execution control unit 210 controls the second service unit 208 to execute the third service that unlocks the second service that has locked the account and prohibited payment. Thus, in a case where the first suspicious determination unit 203 determines that the person is attempting the unauthorized authentication but is not determined to be suspicious by the second suspicious determination unit 205, the second execution control unit 210 controls the second service unit 208 to execute the third service.

In the embodiment described above, S402, the impersonation determination processing, was implemented immediately after S401 in FIG. 4. However, it is not limited thereto, the impersonation determination processing may be executed by S405.

For example, it may be configured to be implemented immediately after the determination of YES in S403 or immediately after the processing of S404. Alternatively, it may be implemented immediately before S401. That is, if it is before the start of execution of S405, the processing may be performed between any of S401 to S404, or may be performed in parallel with any of S401 to S404.

In the embodiment described above, the entrance gate 301a was configured to be imaged by the NW camera 320a. However, the NW camera 320a does not necessarily have to image the entrance gate 301a.

In this case, in order to track the suspicious individual identified by the first suspicious determination unit 203 at the entrance gate 301a, the angle of view of the camera should be set so that the camera at the entrance gate 301a can also obtain the whole body of the suspicious individual.

Then, it may be configured to identify the video of the affected person from each of the other NW cameras based on the full body image and monitor his/her behavior in the second suspicious determination unit 205. In this case, in order to obtain the image of the whole body of the person to be determined as a suspicious individual, the second suspicious determination unit 205 also obtains video data from the first acquisition unit 201. This can reduce restrictions on camera installation and reduce the number of cameras.

In the embodiment described above, the second acquisition unit 204 acquired video data (second data) from the NW cameras 320a to 323a. However, the video data (second data) may be acquired from the face recognition terminal in at least one of booths 310a to 318a.

For example, when a person to be monitored appears at the face recognition terminal, the second suspicious determination unit 205 may determine that the person is a suspicious person using the video data from a predetermined time backward and by observing behavior such as holding a photograph or a smartphone up over the camera.

In addition, this may also be used to determine a person as suspicious based on the fact that his/her face has changed before and after holding it up. This eliminates the need to install NW cameras at the event venue 300a, thereby reducing costs.

In the embodiment described above, the second suspicious determination unit 205 determines the suspiciousness of the affected person (suspicious person) based on the behavior of the person who was determined by the first suspicious determination unit 203 to be attempting the unauthorized authentication.

However, other methods may be used to determine suspiciousness. For example, it is configured to cause the second acquisition unit 204 to acquire video data (second data) from at least one of the face recognition terminals in the booths 310a to 318a.

Then, at the time of authentication for payment, impersonation detection techniques, such as those used in the first suspicious determination unit 203, may be used to determine whether impersonation is taking place.

In addition, some impersonation detection techniques are implemented using only a single still image, while others use multiple frames of video. Using multiple frames, it is possible to determine that the person is not holding up a flat object such as a photograph, but an actual three-dimensional face, for example.

Therefore, the latter is generally more accurate. However, there is a problem in that the throughput decreases. Therefore, the first suspicious determination unit 203 may use still image-based techniques to improve the throughput of the entrance gate. The second suspicious determination unit 205 may be configured to use video-based technology to improve accuracy.

This will increase throughput at the entrance gate while providing a highly accurate decision at the time of payment at booths and other locations. In addition, since when making a payment at the booth, the second suspicious determination unit 205 processes only those people who are determined to be suspicious by the first suspicious determination unit 203, the decrease in throughput during the payment is also limited.

In addition, the second suspicious determination unit 205 may use Active-type impersonation detection, which instructs the user to turn to the side, blink, or the like, and determines whether the user moves as instructed. Such techniques have more time to make a determination but are more accurate. Therefore, the accuracy can be further improved.

In the embodiment described above, the account was locked to prevent payment. However, it is not limited thereto, and the service level may be lowered by other methods. For example, there may be restrictions such as not allowing payments at unmanned booths but allowing payments at manned booths.

Alternatively, it is conceivable that participants in an event may be divided into free users and paid users, or that paid users may be further divided into ranks based on participation fees, or the like. Depending on such user classification, the service level provided at the event may be changed. Therefore, instead of locking the account, such user classification may be changed to restrict the service level.

In the embodiment described above, the status where there would be payments for merchandise sales within the event venue 300a was assumed. However, it may be applied to a status where no payment is made within the event venue 300a and only the entrance gate 301a is present.

In this case, the processing procedures of S406 and S410 in the flowchart in FIG. 4 are unnecessary because control of the payment account is not required. In that case, the second execution control unit 210 and the second service unit 208 may be eliminated as a configuration of the computer device 100.

This allows a person to pass through the entrance gate 301a even if he/she is determined (determined as suspicious) to be a person attempting the unauthorized authentication by the first suspicious determination unit 203. Therefore, the user is not stopped at the gate for entry due to an erroneous determination by the first suspicious determination unit 203, and thus, the user's stress will be reduced.

Furthermore, it prevents people from stagnating and improves throughput. In addition, even in a case where the result of the authentication determination by the first suspicious determination unit 203 is correct, if the second suspicious determination unit 205 determines that a person is suspicious, a security guard is notified, and it is possible to have the suspicious individual leave the event venue.

This allows the service operator to continue business without any loss. The entrance gate 301a may also function as an exit gate, or a separate exit gate may be arranged.

In the embodiment described above, it is described as a computer device (information processing device) 100 that performs service control. However, it may be configured as the computer device 100 that only performs suspicious determination (determination of whether unauthorized authentication is being attempted and whether the person is suspicious individual or not).

In such a case, only the first acquisition unit 201, the authentication unit 202, the first suspicious determination unit 203, the second acquisition unit 204, and the second suspicious determination unit 205 are components, and the results by the first suspicious determination unit 203 and the second suspicious determination unit 205 are output.

Alternatively, the configuration such that the result by the second suspicious determination unit 205 may be adopted. The configuration such that the output results can be saved in the RAM 103 or the external storage device 104 may be adopted.

This allows the accuracy of the suspicious determination to be improved because the second suspicious determination unit 205 further checks a case where the first suspicious determination unit 203 incorrectly determines that unauthorized authentication is being attempted (determined as suspicious).

In particular, the first suspicious determination unit 203 makes a determination based on impersonation detection and the second suspicious determination unit 205 makes a determination based on the behavior, which can be more accurate because they use different criteria to determine whether a person is suspicious individual or not.

Furthermore, the computer device 100 may be configured without the second acquisition unit 204. In this case, the second suspicious determination unit 205 may acquire the video data from the first acquisition unit 201.

For example, the camera at the entrance gate 301a is not used, and only one NW camera that captures the entrance gate is used. When a person comes to the entrance gate 301a, facial recognition is performed by the NW camera, and in a case where the recognition is successful, the entrance gate 301a is unlocked.

In addition, when the person at the time of authentication is suspected to be suspicious by the first suspicious determination unit 203 (when it is determined that the person is attempting the unauthorized authentication), subsequent behaviors are monitored by the second suspicious determination unit 205.

For example, if a person who has been successfully authenticated is tracked and a change in the person's facial image is detected, the affected person can be determined to be a suspicious person because it is suspected that the person has lowered a photograph or other object that was being held up. Thus, it is also possible to adopt a configuration using only one camera.

In the embodiment described above, the processing by the first suspicious determination unit 203 was implemented only on the video data acquired by the camera at the entrance gate 301a. However, it may be implemented at multiple locations, not limited to entrance gate 301a.

For example, it may be implemented at the face recognition terminals in the booths 310a to 318a. In other words, when an attempt is made to authenticate with a face recognition terminal, the first suspicious determination unit 203 determines whether unauthorized authentication is being attempted (determines suspiciousness).

Here, when it is determined that unauthorized authentication is being attempted, it may be monitored by each NW camera by the second suspicious determination unit 205. Alternatively, if there is a sub-gate or the like that further divides the event venue 300a instead of a facial recognition terminal, processing of the first suspicious determination unit 203 may be implemented using the video data.

This makes it possible to lock a person's payment account even if they pass through the entrance gate 301a if they are suspected to be a suspicious person. In addition, even if the lock is accidentally unlocked by the second suspicious determination unit 205, it can be locked again because the processing is performed by the first suspicious determination unit 203 again at multiple locations.

In addition, when locking and unlocking are repeated, the locked state may be maintained. This allows the locked state to be maintained even when the second suspicious determination unit 205 incorrectly determines that the user is not a suspicious person, thereby further improving security.

In the above embodiment, as an example of the first service, unlocking of the entrance gate 301a of the event venue 300a has been described, and as an example of the second service, restriction of the payment service within the event venue 300a has been described. However, it is not limited thereto and may be applied to other services. For example, it may be applied to unlocking a car or starting an engine.

In other words, as the first service, a service that controls the unlocking and locking of car doors is assumed. As the second service, the service is assumed to include post-boarding controls such as engine starting and air conditioning control.

Even if the first suspicious determination unit 203 determines that unauthorized authentication is being attempted (determined as suspicious), the first execution control unit 209 unlocks the door and allows the user to board the vehicle. In addition, the first execution control unit 209 locks the execution of the second service so that it is temporarily prohibited.

Subsequently, when the second suspicious determination unit 205 determines that the user is not a suspicious person from the video image of the user after the ride, the second execution control unit 210 permits the execution of the second service. This increases the probability of a smooth ride, while at the same time preventing more important controls, such as engine starting by suspicious individuals, or the like.

Alternatively, it may be applied to unlocking a smartphone or launching an application. In other words, as the first service, a service that controls the unlocking, or the like of the smartphone is assumed. As the second service, a service that controls the execution of applications in the smartphone is assumed.

Even if the first suspicious determination unit 203 determines that unauthorized authentication is being attempted (determined as suspicious), the smartphone is unlocked. In addition, the second execution control unit 210 temporarily prohibits the execution of the second service.

After that, in a case where the second suspicious determination unit 205 determines that the person is not suspicious person based on the video in which the user sees on the screen while the smartphone is unlocked, the second execution control unit 210 permits the execution of the second service. This increases the probability that the smartphone can be unlocked smoothly, while also preventing suspicious individuals from performing important controls such as execution of the application.

In addition, it may also be used to limit the range of applications that can be executed, rather than prohibiting the execution of applications. For example, this may be realized by changing the privileges of the account. In addition, the above is an example and is not limited thereto.

In the above embodiment, the computer device 100 (information processing device) is configured as one. However, it is not limited thereto and may be configured separately in a plurality of computer devices. For example, the first service unit 207 and the second service unit 208 may be separated as separate devices (information processing devices).

Furthermore, the first acquisition unit 201, the authentication unit 202, the first suspicious determination unit 203 and the first execution control unit 209 may be one device, and the second acquisition unit 204, the second suspicious determination unit 205, the notification unit 206, and the second execution control unit 210 may be another device. The above combination is an example, and any combination can be set when configuring the computer devices separately.

In the above embodiment, the first acquisition unit 201 and the second acquisition unit 204 acquired video data from an imaging device such as a camera. However, it is not limited thereto and other data such as sensor data may be obtained.

For example, the first suspicious determination unit 203 detects impersonation based on video data (first data). However, it is also possible to install a vital sensor to estimate the user's stress level from vital data such as temperature, perspiration, and heart rate, and determine that the user is attempting the unauthorized authentication (determined as suspicious) when the stress level is high.

Similarly, the second suspicious determination unit 205 may also use the vital data to determine whether the person is a suspicious person. Furthermore, the user may be identified by a near field communication (NFC) card without using facial recognition for authentication.

In this case, the vital data are the first and second data. In this way, it is possible to adopt a configuration using other data instead of video data.

In addition, it is assumed that there is an exit gate having the same function as the entrance gate 301a. In such a case, a configuration that a camera installed at the exit gate captures an image of a person exiting the gate, and in a case where the person exiting the gate is determined to be a suspicious person, the exit gate is controlled not to be unlocked (second service) may be adopted. In addition, the entrance gate 301a may be used also as an exit gate.

According to the above, the computer device 100 in the present embodiment does not stop a person at the entrance gate 301a even if it is determined that unauthorized authentication is being attempted by the first suspicious determination unit 203 at the entrance gate 301a (determined as suspicious). Therefore, the throughput at the entrance gate 301a can be improved.

Furthermore, only those people who have been determined to be attempting the unauthorized authentication in the first suspicious determination unit 203 are monitored (tracked) to determine whether they are truly suspicious people in the second suspicious determination unit 205. Thus, there is no need to track all users who enter, and suspicious individuals can be identified by allocating computing resources only to those who are suspected of being suspicious.

This allows for increased throughput while reducing computational resources. Furthermore, if a person is ultimately determined to be a suspicious person, a security guard or other person will be notified, so that measures can be taken to remove the suspicious person. Hence, it also prevents the security level from deteriorating.

### Second Embodiment

In the first embodiment, an example in which a payment account is locked when it is determined that a person is attempting the unauthorized authentication (suspected of being suspicious), and the payment account is unlocked when the suspicion of being a suspicious person is cleared has been described.

In the present embodiment, a form that when it is determined that unauthorized authentication is being attempted (suspected to be suspicious), by pending the payment of fee and implementing the payment when the suspicion of the fraudulent person is cleared will be described.

The computer device 100 of the second embodiment has the same configuration as the computer device 100 of the first embodiment. Therefore, a detailed description of the same configuration and processing as in the first embodiment will be omitted.

A status in which the present embodiment is applied will be described with reference to FIG. 3B. In the present embodiment, at ticket vending machines that allow payment by facial recognition, a status where the user purchase a ticket and then use it to enter a facility such as a zoo or aquarium is assumed.

The ticket vending machine (ticketing device) 302b, which is the device used to obtain the means to gain entry (ticket), is equipped with a camera, and if a user with a face recognition payment account successfully authenticates his/her face, the user can purchase a ticket.

When the entrance gate 301b accepts the ticket, it unlocks the entrance gate 301b and permits entry into a facility 300b. The NW camera 320b and the NW camera 321b are installed in the facility 300b.

The NW camera 322b is installed outside the facility 300b. As illustrated in FIG. 3B), the NW camera 320b and NW camera 321b should be installed (disposed) so that they are in different positions when installed in the facility 300b.

The computer device 100 of the present embodiment functioning as an information processing device issues a ticket even if a person is suspected of being suspicious when purchasing a ticket through face authentication, but does not make payment of the fee.

The user then uses the ticket to gain entry to the facility, but the person suspected of being suspicious is monitored and the payment, that should have been implemented earlier when the suspicion is cleared, is delayed. If suspicion is not cleared, security guards or the like are notified of suspicious people.

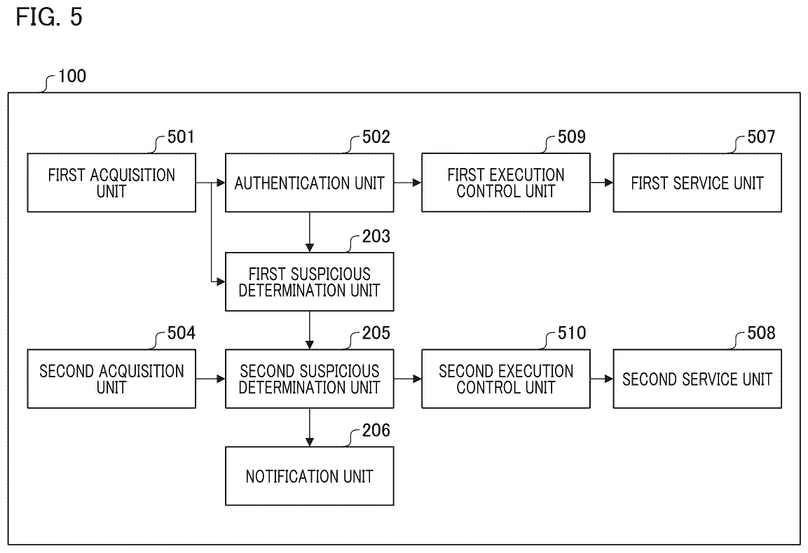

The functional configuration of the computer device 100 of the present embodiment will be described with reference to FIG. 5. FIG. 5 is a diagram illustrating a functional block configuration of the computer device 100 according to the second embodiment.

In FIG. 5, the components with the same numbers as those in FIG. 2 of the first embodiment are the same as those in the first embodiment and are therefore omitted from the description. The computer device 100 of the second embodiment includes a first acquisition unit 501, an authentication unit 502, the first suspicious determination unit 203, a second acquisition unit 504, the second suspicious determination unit 205, and the notification unit 206.

The device further includes a first service unit 507, a second service unit 508, a first execution control unit 509, and a second execution control unit 510.

The first acquisition unit 501 acquires video data (first data) from a camera attached to a ticket vending machine 302b. The authentication unit 502 authenticates the person (the person who makes payment at the ticket vending machine 302b) who appears in the video data acquired by the first acquisition unit 501.

Specifically, similar to the first embodiment, it is identified which payment account the person making the payment at the ticket vending machine 302b is a user of based on the registration database and the acquired video data (first data). In the registration database of the present embodiment, information about the person who holds the payment account is registered.

The second acquisition unit 504 acquires video data (second data) from each NW camera (NW cameras 320b to 322b). The first service unit 507 controls the ticket vending machine 302b to issue tickets (first service). The second service unit 508 controls the payment service and performs charges such as debiting (second service).

The first execution control unit 509 controls the first service unit 507 to issue tickets as the first service in a case where the authentication of the authentication unit 502 is successful. The second execution control unit 510 controls the second service unit 508 to execute the payment processing for the affected person as a second service when the person who has been determined by the first suspicious determination unit 203 to be attempting the unauthorized authentication is determined by the second suspicious determination unit 205 not to be a suspicious person.

Next, the service control processing flow in the present embodiment will be described with reference to the flowchart in FIG. 6. FIG. 6 is a flowchart illustrating a flow of the service control processing in the second embodiment. In addition, each process (step) is represented by adding S to the beginning of the process (step), thereby abbreviating the notation of the process (step).

In S601, the authentication unit 502 searches for the registration database for a person who intends to purchase a ticket at the ticket vending machine 302b, and performs authentication processing of the person. The person authentication processing in S601 can be the same as the first embodiment, so the description will be omitted.

In S602, the first suspicious determination unit 203 determines whether the person whose authentication processing was performed by the authentication unit 502 in S601 is attempting the unauthorized authentication. Specifically, the first suspicious determination unit 203 determines whether the affected person is attempting to impersonate by holding up a photograph for the camera or by other means (whether an act of impersonation is performed).

In S603, the first suspicious determination unit 203 determines whether the authentication of the person whose authentication processing was performed by the authentication unit 502 in S601 was successful or not. In a case where the authentication is successful, the processing proceeds to S604. On the other hand, in a case where the authentication fails, the processing ends. In other words, in a case where the authentication fails, the ticket cannot be purchased.

In S604, the first execution control unit 509 controls the first service unit 507 to issue tickets from the ticket vending machine 302b (execution of first service). In other words, the first execution control unit 509 controls the first service unit 507 to execute the first service regardless of the determination result by the first suspicious determination unit 203 (whether the person whose authentication processing was performed by the authentication unit 502 in S601 was attempting the unauthorized authentication).

In S605, the first suspicious determination unit 203 determines whether unauthorized authentication was attempted (whether there has been impersonation) in S602. In a case where the determination result of S602 is impersonation, the processing proceeds to S606. On the other hand, in a case where the determination result of S602 is not impersonation, the processing proceeds to S609.

In S606, the second suspicious determination unit 205 monitors the person who was determined to be attempting the unauthorized authentication in S602 (the person who has been determined to be suspicious) using the NW cameras 320b to 322b. During the monitoring, the second acquisition unit 504 acquires the video data (second data) that is the monitoring result from the NW cameras 322b to 322b.

In S607, the second suspicious determination unit 205 determines whether the person who has been determined to be attempting the unauthorized authentication in S602 is a suspicious person based on the video data (second data) that is the monitoring result acquired by the second acquisition unit 504 in S606.

In a case where the person who has been determined to be attempting the unauthorized authentication in S602 is determined to be a suspicious person, the processing proceeds to S608. On the other hand, in a case where the person who has been determined to be attempting the unauthorized authentication in S602 is not determined to be a suspicious person, the processing proceeds to S609.

In a case where the person is not determined as suspicious in S607, it means that the first suspicious determination unit 203 erroneously determined that the person to be authenticated is a person who is attempting the unauthorized authentication, but the second suspicious determination unit 205 has corrected the determination as not suspicious (not a suspicious person).

In S608, the notification unit 206 notifies security guards and other relevant people of the presence of a suspicious individual (who was determined to be a suspicious person in S607).

In S609, the second execution control unit 510 controls the second service unit 508 to debit the ticket fee from the payment account of the registered person identified in S601 (execution of the second service).

In the embodiment described above, the payment processing in S609 may be different in content in a case where the person is determined not to be a person attempting the unauthorized authentication (not suspicious) in S605 and in a case where the person is determined not to be a suspicious person in S607.

For example, in a case where the processing is reached to S609 via S607, the billing amount may be reduced to account for the possibility of an error in the determination by the first suspicious determination unit 203. Alternatively, the maximum amount allowed by the payment service may be lowered and payment would not be implemented once the maximum amount is reached.

Alternatively, the same amount of payment may be implemented, but a history may be kept on the payment service side so that a refund request can be made. This makes it possible to reduce the effects of the error in the determination.

In the above embodiment, an example of prepayment, that is, ticketing, is used, but it may be applied to a postpayment system. In the case of postpayment, the billing amount may be increased in a case where the person is determined to be a person attempting the unauthorized authentication. For example, when visiting a medical institution, it is a postpayment system where a person receives treatment after checking in and pay at the end The following describes the form in which it is applied to medical institutions.

In this system, the reception processing is carried out using a reception terminal that uses the individual number card (My Number Card), and a medical examination ticket which lists reception number, examination room, or like is received. The user then goes to the examination room to receive medical treatment, and after the treatment, performs payment processing at the accounting terminal.

The reception terminal is equipped with a camera to determine whether the person seen on the camera is the same as the person associated with the individual number card, and if facial recognition is successful, a medical examination ticket is issued. The accounting terminal reads out the medical examination ticket, calculates the medical fee to be charged, and bills the user, who then pays in cash or by credit card.

In this system, the first service is the issuance of the medical examination ticket at the reception terminal. Additionally, the second service is the settlement of medical expenses at the accounting terminal. Even if the first suspicious determination unit 203 determines the person to be suspicious, the first execution control unit 209 will issue the medical examination ticket.

Subsequently, when the second suspicious determination unit 205 determines from the video of the user in the hospital that the user is not a suspicious person, the second execution control unit 210 controls the charging at the accounting terminal at the normal amount.

On the other hand, in a case where the second suspicious determination unit 205 determines that the user is a suspicious person, a warning may be displayed to the user and an increased amount may be charged. Medical expenses are usually 30% of the patient's income, but it is also possible to increase this to 100% and request an increased amount.

If a staff member or the like determines that the billing was an incorrect decision at the time of billing, the billed amount may be returned to the user for whom the incorrect determination was determined, and payment may be made as normal. This allows for smoother reception processing while allowing different payment methods to be implemented depending on the level of suspiciousness.

According to the computer device 100 in the present embodiment, even if a person is determined as suspicious by the first suspicious determination unit 203 at the ticket vending machine 302b, a ticket is issued by the ticket vending machine 302b, thus preventing a line from forming at the ticket vending machine 302b.

In addition, computational resources can also be reduced because only people who are determined to be attempting the unauthorized authentication (people suspected of being suspicious) are monitored, rather than all people. In addition, it can also prevent the impersonated person from incorrectly charged.

### Third Embodiment

In the present embodiment, an aspect of application of this technology to e-learning, a type of online learning, in which a participant is monitored only when impersonation is suspected, and whether the participant is actually taking the course is determined.

The computer device 100 of the third embodiment has the same configuration as the computer device 100 of the first embodiment. Therefore, a detailed description of the same configuration and processing as in the first embodiment will be omitted.

A status in which the present embodiment is applied will be described. In the present embodiment, participants take the e-learning course at home from a laptop PC or other information processing device. Then, the user logs in to the e-learning course class by facial recognition to take the e-learning course.

The camera on the laptop PC is used for facial recognition. In addition, the same camera will also be used to monitor the participants during the course. It does not have to be a laptop PC, but may consist of a desktop PC and a USB camera, or the like. It may also be a laptop PC but configured for face recognition by a USB camera or other camera.

The functional configuration of the computer device 100 of the present embodiment is described with reference to FIG. 7. FIG. 7 is a diagram illustrating a functional block configuration of the computer device 100 according to the third embodiment.

In FIG. 7, components having the same numbers as those in FIG. 2 of the first embodiment have the same configuration as those in the first embodiment, and therefore description thereof will be omitted. The computer device 100 of the third embodiment includes a first acquisition unit 701, an authentication unit 702, the first suspicious determination unit 203, a second acquisition unit 704, and a second suspicious determination unit 705.

The device further includes a first service unit 707, a second service unit 708, a first execution control unit 709, and a second execution control unit 710.

The first acquisition unit 701 acquires video data (first data) from the laptop PC camera. The second acquisition unit 704 acquires video data (second data) from the laptop PC camera.

The authentication unit 702 authenticates the person (person who makes the payment) who appears in the video data acquired by the first acquisition unit 701. Specifically, it is identified which person is the participant taking the course based on the registration database and video data (first data) as well as the first embodiment.

The information of the participants is registered in the registration database of the present embodiment. Then, the person whose video data was obtained in the first acquisition unit 701 is searched in the registration database to identify which participant it is.

The second suspicious determination unit 705 determines whether the person taking the course is a suspicious person (whether the course is suspicious) based on the video data (second data) during the course. In particular, it is determined whether a different person is taking the course, assuming that the course is being taken by an imposter or the like.

For example, when the face of a person authenticated by the authentication unit 702 is not present in the video and a face of a person different from the authenticated face is recognized a certain number of times, it is suspiciously determined to have attended the course. Alternatively, when the face of a different person is recognized for more than a certain period of time, it is determined as a suspicious course.

Alternatively, in order to detect when a student leaves the school without attending the course, a suspicious course is determined when no person is recognized in the video image for a certain period of time. These are only examples and the methods used to determine suspicious people are not limited to these.

The first service unit 707 performs e-learning service such as starting e-learning (first service). The second service unit 708 is a service for recording course history, and records information such as whether the person has taken the course or not (second service). In addition, the second service unit 708 may also record the status of the course, such as whether it is in progress or completed, and the duration of the course.

The first execution control unit 709 controls the first service unit 707 to start e-learning as the first service (start of online learning) in a case where the authentication of the authentication unit 702 is successful. The second execution control unit 710 controls the second service unit 708 and performs recording processing as a normal attendance when the person who was determined to be attempting the unauthorized authentication by the first suspicious determination unit 203 is determined not to be a suspicious person by the second suspicious determination unit 705.

In addition, in a case where the second execution control unit 710 determines that the person who has been determined to be attempting the unauthorized authentication by the first suspicious determination unit 203 was determined to be a suspicious person by the second suspicious determination unit 705, recording processing is performed as a suspicious course. Thus, the second suspicious determination unit 705 records the course based on the determination results of the second suspicious determination unit 705 as a second service.

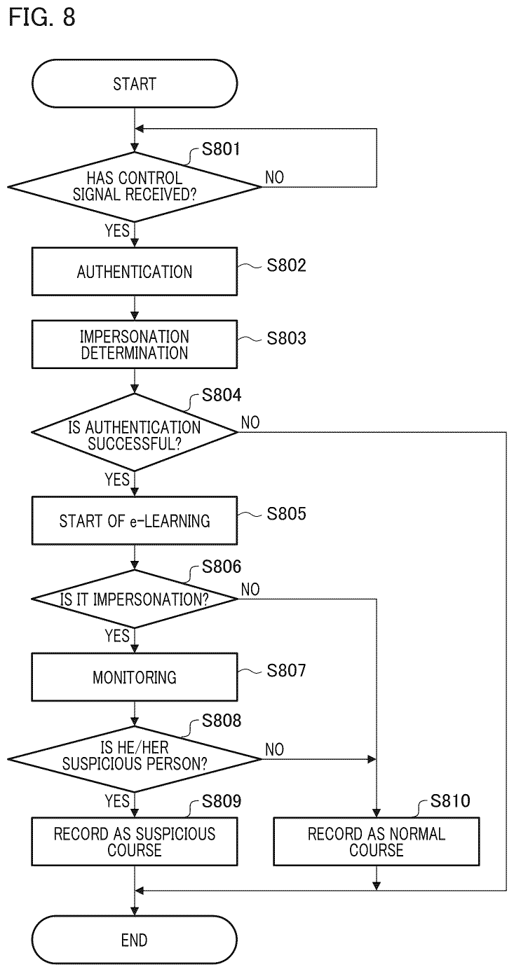

Next, the service control processing flow in the present embodiment is described with reference to the flowchart in FIG. 8. FIG. 8 is a flowchart illustrating a flow of the service control processing in the first embodiment. In addition, each process (step) is represented by adding S to the beginning of the process (step), thereby abbreviating the notation of the process (step).

In S801, the authentication unit 702 determines whether a control signal regarding the e-learning course has been received. In a case where it is determined that a control signal (control command) regarding e-learning course is received, the processing proceeds to S802.

On the other hand, in a case where it is determined that no control signal regarding the e-learning course has been received, the device waits until it receives a control signal related to taking the e-learning course. For example, a control signal for identifying the e-learning course to be taken or a control signal indicating that the user wants to log in to the e-learning class may be used as a control signal for the e-learning course.

To select the e-learning course, the user who plans to take the course selects the e-learning course to be taken at an e-learning site or other site using the input device 109 or the like.

In S802, the authentication unit 702 searches for the registration database for a person who intends to take the e-learning course, and performs authentication processing of the person. The person authentication processing in S802 can be the same as the first embodiment, so the description will be omitted.

In S803, the first suspicious determination unit 203 determines whether the person whose authentication processing was performed by the authentication unit 702 in S802 is attempting the unauthorized authentication. Specifically, the first suspicious determination unit 203 determines whether the affected person is attempting to impersonate by holding up a photograph for the camera or by other means (whether an act of impersonation is performed).

In S804, the first suspicious determination unit 203 determines whether the person whose authentication processing was performed by the authentication unit 702 in S802 is attempting the unauthorized authentication. In a case where the authentication is successful, the processing proceeds to S805. On the other hand, in a case where the authentication fails, the processing ends. In other words, the e-learning courses are not available in this case.

In S805, the first execution control unit 709 controls the first service unit 707 to start the e-learning (execution of the first service). In other words, the first execution control unit 709 controls the first service unit 707 to execute the first service regardless of the determination result by the first suspicious determination unit 203 (whether the person whose authentication processing was performed by the authentication unit 702 in S802 was attempting the unauthorized authentication).

In S806, the first suspicious determination unit 203 determines whether the unauthorized authentication was attempted (whether there is impersonation) in S803. In a case where there is impersonation in the determination result of S803, the processing proceeds to S807. On the other hand, in a case where there is no impersonation in the determination result of S803, the processing proceeds to S810.

In S807, the second suspicious determination unit 705 monitors the person who was determined to be attempting the unauthorized authentication in S803 (the person who has been determined to be suspicious) using the laptop PC camera. The second acquisition unit 704 acquires the video data (second data) that is the monitoring result from the laptop PC during the monitoring.

In S808, the second suspicious determination unit 705 determines whether the person who has been determined to be attempting the unauthorized authentication in S803 is a suspicious person based on the video data (second data) that is the monitoring result acquired by the second acquisition unit 704 in S807.

In a case where the person who has been determined to be attempting the unauthorized authentication in S803 is determined to be a suspicious person, the processing proceeds to S809. On the other hand, in a case where the person who has been determined to be attempting the unauthorized authentication in S803 is not determined to be a suspicious person, the processing proceeds to S810.

In a case where the person is not determined as a suspicious person in S808, it means that the first suspicious determination unit 203 erroneously determined that the person to be authenticated is a person who is attempting the unauthorized authentication, but the second suspicious determination unit 705 has corrected the determination as not suspicious (not a suspicious person).

In S809, the second execution control unit 710 controls the second service unit 708 to record that the person identified in S802 was a “suspicious course” with respect to his/her course history (execution of the second service).

In S810, the second execution control unit 710 controls the second service unit 708 to record that the course history of the person identified in S802 was a “normal course” (second service execution).

Although the description has been given in the above embodiment using e-learning as an example, it may also be applied to “taking a qualification examination”. For example, there are also places such as test centers that have a plurality of PCs and allow people to take the examination all at once. In such places, NW cameras and other equipment may also be installed and used for the second suspicious determination unit 705.

The computer device 100 of the third embodiment was configured without the notification unit 206, but may be configured to have the notification unit 206. In such a case, when it is determined that unauthorized authentication is being attempted by the second suspicious determination unit 705, for example, an examination supervisor may be notified to that effect.

The present embodiment can also be applied to “course attendance” and the like. For example, attendance could be taken by passing around a facial recognition tablet among students. Furthermore, it is configured to image students using a network camera. The NW camera may then monitor the person suspected of being an impersonator during tablet authentication, and in a case where the person is not cleared of suspiciousness (in a case where it is determined as a suspicious person), it may be recorded as a suspicious attendance or the like.

According to the above, the computer device 100 in the present embodiment monitors participants only when impersonation is suspected. Therefore, it is not necessary to monitor all participants, and computing resources can be allocated only to people suspected of being suspicious, allowing for more efficient processing.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing device or the like through a network or various storage media. Then, a computer (or a CPU, an MPU, or the like) of the information processing device or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-016552, filed on Feb. 6, 2024, which is hereby incorporated by reference herein in its entirety.

What is claimed is:

1. An information processing device comprising:
at least one processor; and
a memory coupled to the at least one processor, the memory storing instructions that, when executed by the at least one processor, cause the at least one processor to:
acquire first data,
authenticate a person based on the first data,
perform a first determination of whether a person to be authenticated by the authentication is attempting the unauthorized authentication, and
perform, in a case where it is determined that the unauthorized authentication is being attempted in the first determination, a second determination of whether the person to be authenticated is a suspicious person.

2. The information processing device according to claim 1, wherein the memory storing further instructions that, when executed by the at least one processor, cause the at least one processor to:
monitor a person who has been determined to be attempting the unauthorized authentication by the first determination, and
determine whether the person who has been determined to be attempting the unauthorized authentication by the first determination is a suspicious person based on a monitoring result in the second determination.

3. The information processing device according to claim 1, wherein the memory storing further instructions that, when executed by the at least one processor, cause the at least one processor to:
acquire the second data, wherein
in the second determination, it is determined whether the person who has been determined by the first determination to be attempting the unauthorized authentication is a suspicious person based on the second data.

4. The information processing device according to claim 3, wherein video data is acquired as the second data from at least one imaging unit.

5. The information processing device according to claim 1, wherein video data is acquired as the first data from imaging unit capable of imaging at least a face of the person.

6. The information processing device according to claim 1, wherein, in the second determination, it is determined whether the person who has been determined to be attempting the unauthorized authentication is a suspicious person based on a behavior of the person who has been determined to be attempting the unauthorized authentication.

7. The information processing device according to claim 1, wherein the memory storing further instructions that, when executed by the at least one processor, cause the at least one processor to:
perform, in a case where the person who has been determined to be attempting the unauthorized authentication in the second determination is determined to be a suspicious person, perform a predetermined notification.

8. The information processing device according to claim 1, wherein the memory storing further instructions that, when executed by the at least one processor, cause the at least one processor to:
perform control such that a first service is executed regardless of the determination result of the first determination.

9. The information processing device according to claim 8, wherein the first service is at least one of opening and closing a gate, issuing a ticket for entry, and starting online learning.

10. The information processing device according to claim 8, wherein a second service is controlled to be executed according to the determination result of in the first determination.

11. The information processing device according to claim 8, wherein, in a case where it is determined that the unauthorized authentication is being attempted in the first determination, control is performed to execute control of payment as a second service.

12. The information processing device according to claim 10, wherein the memory storing further instructions that, when executed by the at least one processor, cause the at least one processor to:
execute a third service to unlock the second service, and
perform, in a case where it is determined that the person is attempting the unauthorized authentication in the first determination, but it is not determined that the person is a suspicious person in the second determination, control to execute the third service.

13. The information processing device according to claim 1, wherein the memory storing further instructions that, when executed by the at least one processor, cause the at least one processor to:
perform control to execute a first service regardless of a determination result by the first determination, and
perform control of payment as a second service according to the determination result of the first determination or the second determination.

14. The information processing device according to claim 8, wherein the memory storing further instructions that, when executed by the at least one processor, cause the at least one processor to:
perform, in a case where the first service is an initiation of online learning, recording an attendance based on the second determination as a second service.

15. A control method for an information processing device, the method comprising:
acquiring of first data;
authenticating of a person based on the first data;
performing of a first determination of whether a person to be authenticated by the authentication is attempting the unauthorized authentication; and
performing of, in a case where it is determined that the unauthorized authentication is being attempted in the first determination, a second determination of whether the person to be authenticated is a suspicious person.

16. A non-transitory computer-readable storage medium configured to store a computer program comprising instructions for executing following processes:
acquiring of first data;
authenticating of a person based on the first data;
performing of a first determination of whether a person to be authenticated by the authentication is attempting the unauthorized authentication; and
performing of, in a case where it is determined that the unauthorized authentication is being attempted in the first determination, a second determination of whether the person to be authenticated is a suspicious person.
